(19) United States
(12) Patent Application Publication
(10) Pub. No.: US 2021/0063182 A1
(43) Pub. Date: Mar. 4, 2021

(54) SYSTEM AND METHOD FOR SUGGESTING POINTS OF INTEREST ALONG A VEHICLE'S ROUTE

(71) Applicant: TOYOTA MOTOR ENGINEERING & MANUFACTURING NORTH AMERICA, INC., PLANO, TX (US)

(72) Inventors: CLINTON J. WILLIAMS, Saline, MI (US); NARENDRAN NARAYANASAMY, Irvine, CA (US)

(21) Appl. No.: 16/554,463

(22) Filed: Aug. 28, 2019

(51) Int. Cl. G01C 21/34

(52) U.S. Cl. CPC G01C 21/3476; G01C 21/3492

(57) ABSTRACT

Systems and methods are provided for suggesting points of interest along a vehicle's route. Some methods include determining a route of a vehicle; determining a current location of the vehicle on the route; predicting a future location of the vehicle based on the route and current location; selecting one or more points of interest according to the future location of the vehicle, without human intervention; and displaying a respective photograph of each selected scenic location on a display of the vehicle.

### TECHNICAL FIELD

The present disclosure relates generally to vehicles, and in particular, some implementations may relate to vehicles that suggest points of interest.

### DESCRIPTION OF RELATED ART

Drivers enjoy visiting points of interest in their vehicles, but are often unaware of such points of interest, even when they are near.

### BRIEF SUMMARY OF THE DISCLOSURE

According to various embodiments of the disclosed technology, systems and methods are provided for suggesting points of interest along a vehicle's route. In general, one aspect disclosed features a system, comprising a hardware processor; and a non-transitory machine-readable storage medium encoded with instructions executable by the hardware processor to perform a method comprising: determining a route of a vehicle; determining a current location of the vehicle on the route; predicting a future location of the vehicle based on the route and current location; selecting one or more points of interest according to the future location of the vehicle, without human intervention; and displaying a respective photograph of each selected scenic location on a display of the vehicle.

Embodiments of the system may include one or more of the following features. Some embodiments comprise displaying a map on the display of the vehicle; and displaying indicators of the points of interest on the map. Some embodiments comprise receiving a user selection of one of the points of interest; determining a route to the one of the points of interest; and displaying the route to the one of the points of interest on the display of the vehicle. Some embodiments comprise selecting the one or more points of interest according to a profile of an occupant of the vehicle. Some embodiments comprise selecting the one or more points of interest only when the route is not a route frequently traveled by the occupant. Some embodiments comprise selecting the one or more points of interest according to criteria concerning the one or more points of interest. In some embodiments, the criteria include at least one of: a profile of an occupant of the vehicle; popularity; weather conditions; traffic levels; predicted times of arrival of the vehicle at the points of interest; and occurrence of natural disasters.

In general, one aspect disclosed features a non-transitory machine-readable storage medium encoded with instructions executable by the hardware processor to perform a method comprising: determining a route of a vehicle; determining a current location of the vehicle on the route; predicting a future location of the vehicle based on the route and current location; selecting one or more points of interest according to the future location of the vehicle, without human intervention; and displaying a respective photograph of each selected scenic location on a display of the vehicle.

Embodiments of the media may include one or more of the following features. Some embodiments comprise displaying a map on the display of the vehicle; and displaying indicators of the points of interest on the map. Some embodiments comprise receiving a user selection of one of the points of interest; determining a route to the one of the points of interest; and displaying the route to the one of the points of interest on the display of the vehicle. Some embodiments comprise selecting the one or more points of interest according to a profile of an occupant of the vehicle. Some embodiments comprise selecting the one or more points of interest only when the route is not a route frequently traveled by the occupant. Some embodiments comprise selecting the one or more points of interest according to criteria concerning the one or more points of interest. In some embodiments, the criteria include at least one of: a profile of an occupant of the vehicle; popularity; weather conditions; traffic levels; predicted times of arrival of the vehicle at the points of interest; and occurrence of natural disasters.

In general, one aspect disclosed features a method comprising: determining a route of a vehicle; determining a current location of the vehicle on the route; predicting a future location of the vehicle based on the route and current location; selecting one or more points of interest according to the future location of the vehicle, without human intervention; and displaying a respective photograph of each selected scenic location on a display of the vehicle.

Some embodiments comprise displaying a map on the display of the vehicle; and displaying indicators of the points of interest on the map. Some embodiments comprise receiving a user selection of one of the points of interest; determining a route to the one of the points of interest; and displaying the route to the one of the points of interest on the display of the vehicle. Some embodiments comprise selecting the one or more points of interest according to a profile of an occupant of the vehicle. Some embodiments comprise selecting the one or more points of interest only when the route is not a route frequently traveled by the occupant. Some embodiments comprise selecting the one or more points of interest according to criteria concerning the one or more points of interest.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for suggesting points of interest in accordance with one embodiment of the systems and methods described herein.

FIG. 3 illustrates an example architecture for suggesting points of interest in accordance with one embodiment of the systems and methods described herein.

FIG. 4 illustrates an example dashboard of a vehicle.

FIG. 5 illustrates an image representing selected points of interest that may be presented on a display panel of the vehicle according to some embodiments.

FIG. 6 illustrates an image that presents the selected points of interest using a map according to some embodiments.

FIG. 7 illustrates an image that presents selected points of interest using a map according to some embodiments.

FIG. 8 is an example computing component that may be used to implement various features of embodiments described in the present disclosure.

The figures are not exhaustive and do not limit the present disclosure to the precise form disclosed.

### DETAILED DESCRIPTION

Drivers enjoy visiting points of interest in their vehicles, but may be unaware of such points of interest, even when they are nearby. Conversely, there may be so many points of interest that a driver may have trouble choosing among them, especially while driving. And drivers often become aware of points of interest only one at a time, and only at the last moment, for example by seeing a highway sign at an exit for the point of interest, or by receiving an ad on a smartphone or vehicle head unit. This situation leaves the driver little opportunity to consider and weigh the merits of multiple points of interest.

Various embodiments of the present disclosure may be implemented to solve some or all of these problems. As described in detail below, the disclosed embodiments implement an inventive concept that provides a novel approach to addressing point-of-interest information for vehicle uses beyond conventional point-of-interest operations and changes the operation of the computing system of the vehicle in a number of ways. Embodiments may allow a navigation system or other computing system to retrieving, filter and present point-of-interest information in new and different ways that involve operations beyond the conventional approaches to retrieving, filtering and presenting point-of-interest information.

Embodiments of the systems and methods disclosed herein can provide vehicles that automatically identify and suggest points of interest along the route of the vehicle. According to these embodiments, the vehicle may predict future locations of the vehicle. For example, the vehicle may determine its current location, and a route the vehicle is taking. The vehicle may predict the future locations based on its current location and the route.

The vehicle may then identify points of interest based on the predicted future locations of the vehicle. For example, the vehicle may store a database of points of interest, and may index this database according to the future locations of the vehicle. By suggesting points of interest the vehicle will reach at some future time, the disclosed technology provides the driver adequate time to consider the suggestions, and to discuss them with other occupants of the vehicle to reach and agreement. Any points of interest may be included, for example such as scenic locations, restaurants, entertainment establishments, museums, and the like. It should be noted that all of the examples described in this disclosure are provided only for purposes of explanation, and should not be considered limiting.

The vehicle may then suggest some or all of the identified points of interest to the occupants of the vehicle. For example, the vehicle may display photographs and videos of the points of interest on the display panel of the vehicle. The vehicle may provide additional information for each point of interest, for example such as the name of the point of interest, travel time required to reach the point of interest, and the like. The vehicle may also announce some of this information using an audio system of the vehicle. By providing this information to the vehicle occupants, the disclosed technology provides sufficient information for the occupants to choose a point of interest that all will enjoy visiting.

In some embodiments, the vehicle may filter the identified points of interest according to various criteria. The criteria may be obtained from profiles of the occupants of the vehicle. For example, the profiles may indicate interests of the occupants. The vehicle may use these interests to rank and filter the identified points of interest prior to presenting them to the occupants of the vehicle. Other criteria may be employed, for example such as weather conditions. For example, when a scenic overlook is fogged in, the vehicle may not present the scenic overlook as a point of interest. By ranking and filtering the points of interest according to the interests of the occupants, the disclosed technology suggests only those points of interest the occupants will enjoy, thereby simplifying and shortening their decision process.

Occupants of the vehicle may select one or more of the points of interest. For example, when the display panel is implemented as a touchscreen, an occupant may touch one of the photographs of the points of interest. In response, the vehicle may display more information concerning the points of interest. For example, the vehicle may display a map that includes indicators at the locations of the points of interest. The map may also include further information for the points of interest, for example such as the names of the points of interest, the types of the points of interest, the photographs of the points of interest, and the like.

In response to user selection of a point of interest, the vehicle may determine or more routes the vehicle may take to reach the selected point of interest. The vehicle may display the route on the map. In response to user selection of one of the routes, the vehicle may provide detailed navigation instructions to the occupants, for example via the display panel, the audio system, and the like.

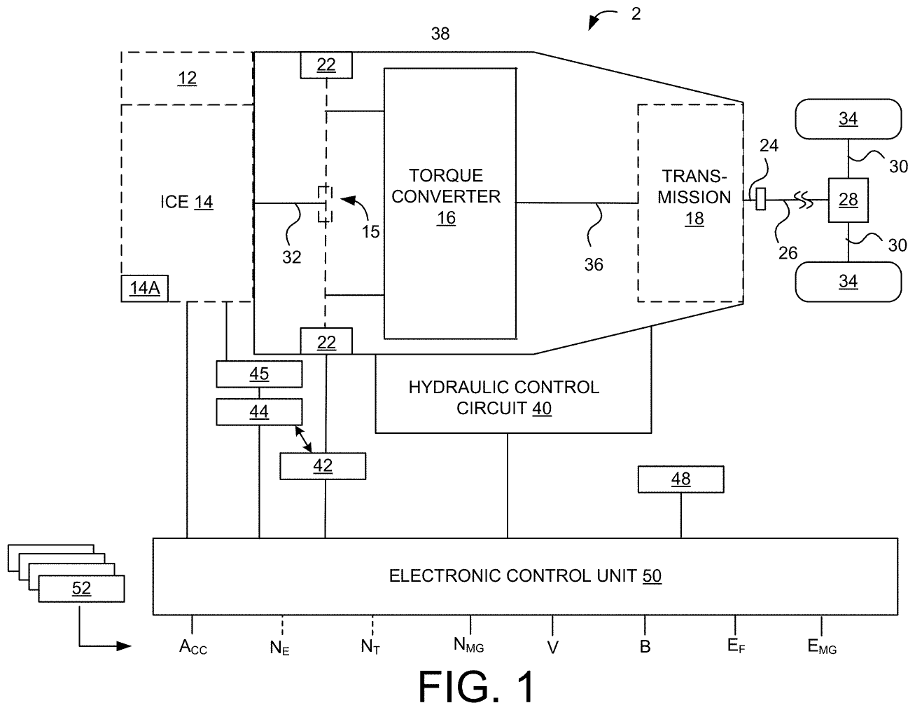

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for suggesting points of interest can be implemented in other types of vehicle including gasoline- or diesel-powered vehicles, fuel-cell vehicles, electric vehicles, or other vehicles.

FIG. 1 illustrates a drive system of a vehicle 102 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 102 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 102 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 102. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MS}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 102 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The examples of FIG. 1 are provided for illustration purposes only as examples of vehicle systems with which embodiments of the disclosed technology may be implemented. One of ordinary skill in the art reading this description will understand how the disclosed embodiments can be implemented with vehicle platforms.

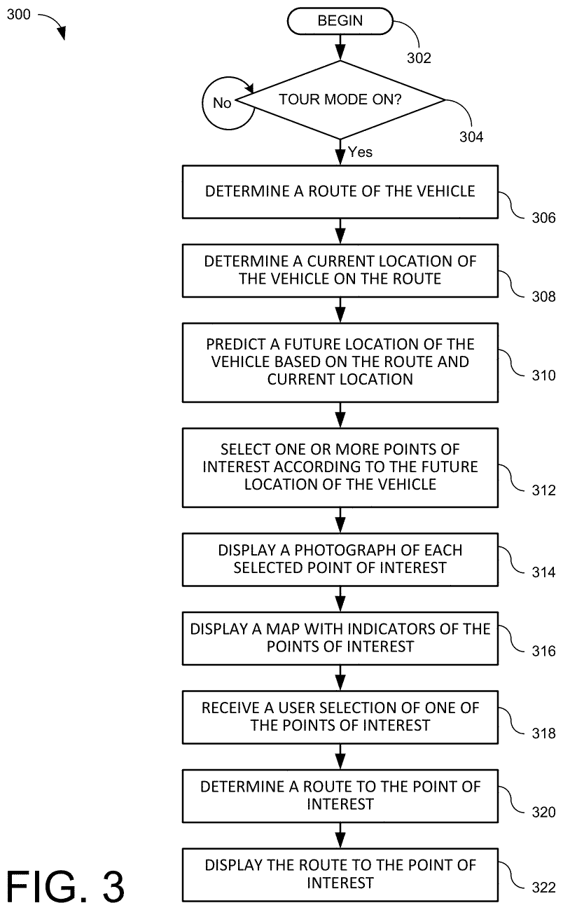

FIG. 3 illustrates an example architecture for suggesting points of interest in accordance with one embodiment of the systems and methods described herein. Referring now to FIG. 3, in this example, the tour system 200 includes a tour circuit 210, a plurality of sensors 52, and a plurality of vehicle systems 58. Sensors 52 and vehicle systems 58 can communicate with tour circuit 210 via a wired or wireless communication interface. Although sensors 52 and vehicle systems 58 are depicted as communicating with tour circuit 210, they can also communicate with each other as well as with other vehicle systems. Tour circuit 210 can be implemented as an ECU or as part of an ECU such as, for example electronic control unit 50. In other embodiments, tour circuit 210 can be implemented independently of the ECU.

Tour circuit 210 in this example includes a communication circuit 201, a decision circuit 203 (including a processor 206 and memory 208 in this example) and a power supply 212. Components of tour circuit 210 are illustrated as communicating with each other via a data bus, although other communication in interfaces can be included. Tour circuit 210 in this example also includes a manual tour switch 205 that can be operated by the user to manually select the tour mode.

Processor 206 can include a GPU, CPU, microprocessor, or any other suitable processing system. The memory 208 may include one or more various forms of memory or data storage (e.g., flash, RAM, etc.) that may be used to store instructions and variables for processor 206 as well as any other suitable information. Memory 208, can be made up of one or more modules of one or more different types of memory, and may be configured to store data and other information as well as operational instructions that may be used by the processor 206 to tour circuit 210.

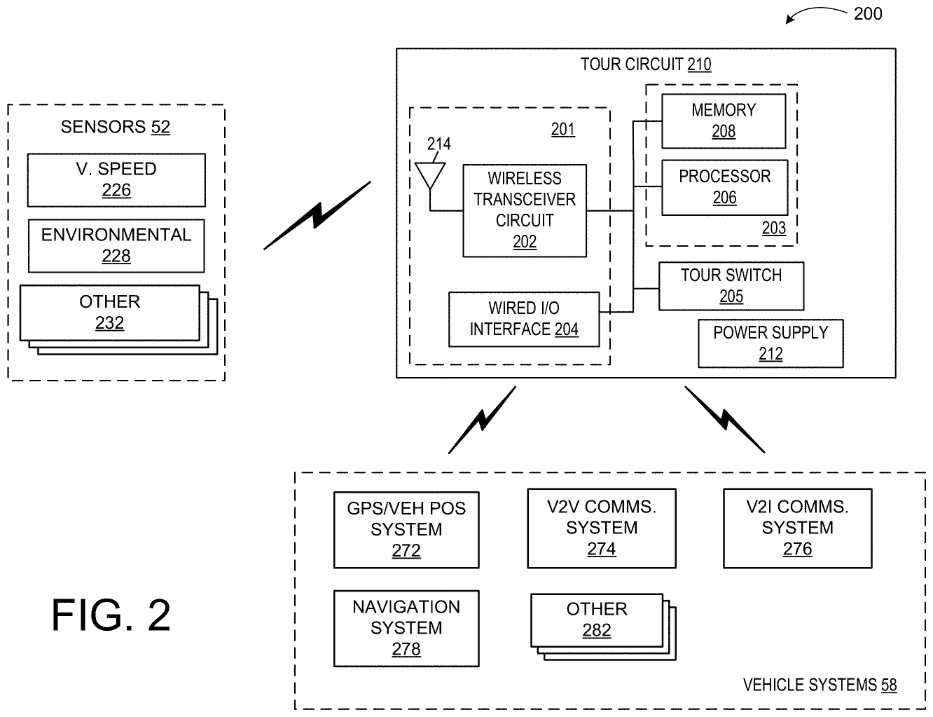

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a tour circuit 210.

Communication circuit 201 may include either or both of a wireless transceiver circuit 202 with an associated antenna 214 and a wired I/O interface 204 with an associated hardwired data port (not illustrated). As this example illustrates, communications with tour circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by tour circuit 210 to/from other entities such as sensors 52 and vehicle systems 58.

Wired I/O interface 204 can include a transmitter and a receiver (not shown) for hardwired communications with other devices. For example, wired I/O interface 204 can provide a hardwired interface to other components, including sensors 52 and vehicle systems 58. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 52 can include, for example, sensors 52 such as those described above with reference to the example of FIG. 1. Sensors 52 can include additional sensors that may or not otherwise be included on a standard vehicle 10 with which the tour system 200 is implemented. In the illustrated example, sensors 52 include vehicle speed sensors 214, and environmental sensors 228 (e.g., to detect weather conditions). Additional sensors 232 can also be included as may be appropriate for a given implementation of tour system 200.

Vehicle systems 58 can include any of a number of different vehicle components or subsystems used to control or monitor various aspects of the vehicle and its performance. In this example, the vehicle systems 58 include the vehicle systems 58 include a GPS or other vehicle positioning system 272; a vehicle-to-vehicle (V2V) communications system 274, a vehicle-to-infrastructure (V2I) communications system 276, a navigation system 278, and other vehicle systems 282.

During operation, tour circuit 210 can receive information from various vehicle sensors to determine whether the tour mode should be activated. Also, the driver may manually activate the tour mode by operating tour switch 205. Communication circuit 201 can be used to transmit and receive information between tour circuit 210 and sensors 52, and tour circuit 210 and vehicle systems 58. Also, sensors 52 may communicate with vehicle systems 58 directly or indirectly (e.g., via communication circuit 201 or otherwise).

In various embodiments, communication circuit 201 can be configured to receive data and other information from sensors 52 that is used in determining whether to activate the tour mode. Additionally, communication circuit 201 can be used to send an activation signal or other activation information to various vehicle systems 58 as part of entering the tour mode. For example, as described in more detail below, communication circuit 201 can be used to send signals to, for example, one or more of: the vehicle position system 272 to obtain the current position and speed of the vehicle; the V2V communications system 274 to communicate with other vehicles, the V2I communications system 276 to communicate with roadway infrastructure, and the navigation system 278 to provide navigation assistance. The decision regarding what action to take via these various vehicle systems 58 can be made based on the information detected by sensors 52. Examples of this are described in more detail below.

FIG. 3 illustrates a process 300 for a vehicle for automatically suggesting points of interest along the vehicle's route according to embodiments of the disclosed technology. While elements of the process 300 are described in a particular sequence, it should be understood that certain elements of the process 300 may be performed in other sequences, may be performed concurrently, may be omitted, or any combination thereof. And while the elements of the process 300 are described with reference to the vehicle, it should be understood that in various embodiments, one or more of these elements may be implemented outside the vehicle, for example in a cloud computing environment.

Referring to FIG. 3, the process 300 begins, at 302. The tour circuit 210 of the vehicle first may determine whether the tour mode is on, at 304. This may include determining whether the tour mode has been activated, for example manually by the driver using the tour switch 205. The tour circuit 210 may continue this determination until the tour mode is activated. In some embodiments, the vehicle may activate the tour mode automatically, for example when the vehicle is started, when routing through the vehicle navigation system 278 is initiated, when the vehicle (e.g., the vehicle navigation system 278) determines it is taking an unusual route, and the like. In some embodiments, the vehicle may deactivate the tour mode automatically, for example when the vehicle determines it is taking a route regularly traveled, such as a daily commuting route.

When the tour mode is active, the tour circuit 210 may determine a route of the vehicle, at 306. The route of the vehicle may be determined in any manner. For example, when the vehicle's navigation system 278 is providing navigation assistance to the driver of the vehicle according to a chosen route, that route may be provided to the tour circuit 210. As another example, the route may be provided by a portable electronic device, such as a smart phone, that the driver is using for navigation. As another example, the tour circuit 210 may predict a route based on the vehicle's position, direction, speed, and the like. For example, the tour circuit 210 may obtain the vehicle speed from the vehicle speed sensor 226.

The tour circuit 210 may also determine a current location of the vehicle on the route, at 308. For example, the tour circuit 210 may receive the current location of the vehicle from the vehicle positioning system 272. As another example, the current location of the vehicle may be received from a portable electronic device, such as a smart phone, operated by one of the occupants of the vehicle.

The tour circuit 210 may predict future locations of the vehicle based on the determined route of the vehicle, and the determined current location of the vehicle, at 310. This determination may be based on other information as well, for example such as the direction and speed of the vehicle, road conditions, traffic conditions, weather conditions, and the like. Additionally, artificial intelligence or machine learning techniques can be used to predict future locations of the vehicle based on past behavior of the vehicle operator or occupants or based on crowd-sourced data from a number of other vehicles traversing the same or similar route. This empirical information can be used to train and refine an AI model to predict future locations of the vehicle.

The tour circuit 210 may select one or more points of interest along the route or in the vicinity of predicted future locations of the vehicle, at 312. For example, the tour circuit 210 may select points of interest the vehicle will pass near. In some embodiments, the vehicle may store a database of points of interest. In these embodiments, selecting points of interest may include indexing the database with the future locations of the vehicle. In some embodiments, the tour circuit 210 may further process a set of selected points of interest. For example, the tour circuit 210 may eliminate one or more points of interest from the set by filtering the points of interest according to one or more criteria.

In some embodiments, the points of interest may be filtered or ranked according to the interests of the occupants of the vehicle. In these embodiments, the interests of the occupants of the vehicle may be obtained from profiles of the occupants. The profiles may be stored in the vehicle, stored on personal electronic devices of the occupants such as smart phones, stored on social media websites, and the like. For example, when the interests indicate that the occupants prefer beaches to museums, the tour circuit 210 may remove any museums from the set of points of interest when the set includes a beach. These interests may be collected based on prior activities conducted by the user, user preferences entered into the system, user purchases, user social media posts or activities, and so on.

In another embodiment, points of interest may be filtered or ordered based on popularity among other users. For example, certain points of interest in a geographic area may receive a lot of visitors while others draw little attention. This information can be gathered from the navigation system of various vehicles or it can be obtained from third-party data providers (e.g., website ratings). Any filtered or ranking criteria may be used. The set of points of interest may be filtered or ranked according to their popularity. For example, unpopular points of interest may be removed from the set. Conversely, extremely popular points of interest may be removed from the set, for example when an occupant's profile reveals a desire to avoid crowds.

The set of points of interest may be filtered or ranked according to nearby traffic levels. For example, when the area surrounding a point of interest is heavily congested with traffic, that point of interest may be removed from the set.

The set of points of interest may be filtered according to weather conditions. For example, outdoor points of interest may be removed from the set when inclement weather is expected.

The set of points of interest may be filtered or ranked according to predicted times of arrival of the vehicle at the point of interest. For example, when a point of interest serves meals, a rank of that point of interest may be increased when the vehicle is predicted to arrive at a mealtime. As another example, when a point of interest is expected to be closed to the public when the vehicle is predicted to arrive, that point of interest may be removed from the set of points of interest.

The set of points of interest may be filtered or ranked according to the occurrence of natural disasters. For example, a viewpoint for viewing a solar eclipse may be removed from the set of points of interest when nearby forest fires threaten the point of interest, or smoke from the fires is expected to obscure the view of the solar eclipse. Of course, many other filtering or ranking examples are possible.

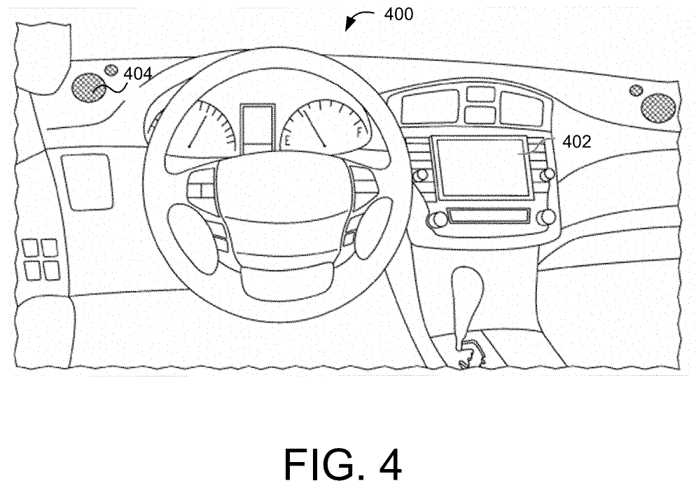

In some embodiments, the tour circuit 210 may display photographs and videos of one or more of the points of interest, at 314. FIG. 4 illustrates an example dashboard 400 of a vehicle. Referring to FIG. 4, the dashboard 400 includes a display panel 402. In this embodiment, the tour circuit 210 may display the photographs and videos on the display panel 402. The vehicle may include an audio system that includes one or more speakers 404. The tour circuit 210 may provide audio information concerning the points of interest using the speakers 404. For example, the tour circuit 210 may announce information concerning the points of interest, such as names, distances, expected times of arrival, and the like.

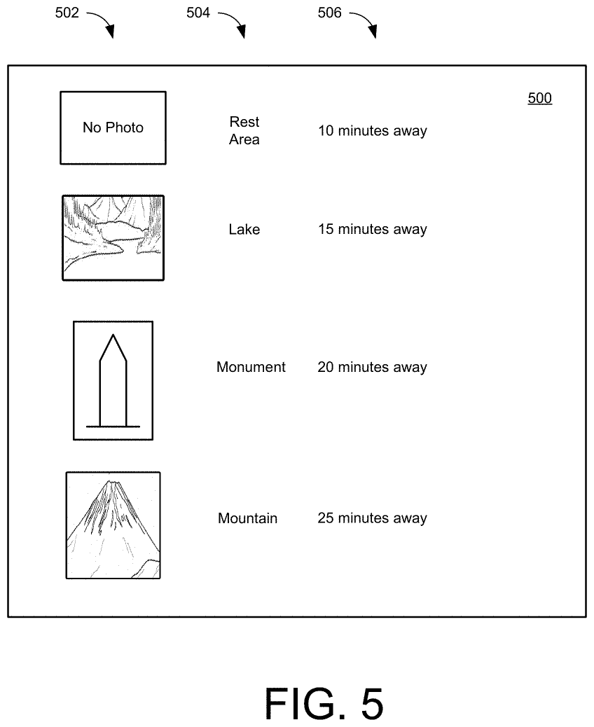

FIG. 5 illustrates an image 500 that may be presented on a display panel of the vehicle. In the example of FIG. 5, the image 500 may present the top four points of interest selected by the tour circuit 210. In the example of FIG. 5, the presented points of interest include a rest area, a lake, a monument, and a mountain. For each of the presented points of interest, the image 500 includes a photograph if one is available, as indicated at 502. Referring to FIG. 5, no photo is available for the rest area. For each point of interest, the image 500 may include further information. In the example of FIG. 5, the image 500 includes the name of each point of interest, as indicated at 504, and an estimated time of travel to the point of interest, at 506.

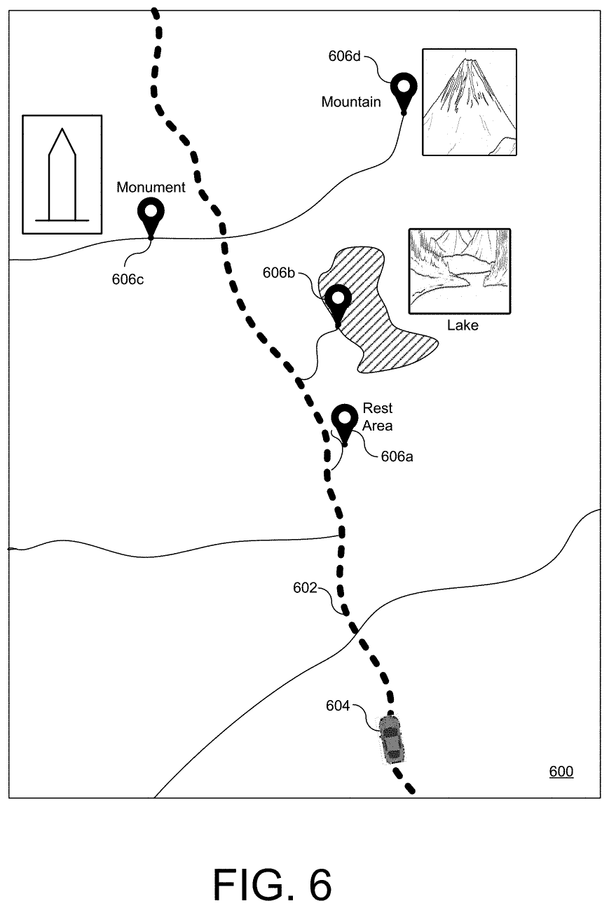

Referring again to the process 300 of FIG. 3, in some embodiments, the tour circuit 210 may present the selected points of interest using a map, at 316. FIG. 6 illustrates an image 600 according to these embodiments. Referring to FIG. 6, the image 600 represents a map that shows the route of the vehicle, at 602, as well as the current position of the vehicle, at 604. The image 600 may also include indicators of the points of interest. Referring again to FIG. 6, the image includes map pins 606a,b,c,d representing locations of the rest area, lake, monument, and mountain, respectively. The image 600 may include the photographs or videos for the points of interest if they are available. Referring again to FIG. 6, the image 600 includes photographs for the lake, monument, and mountain.

In some embodiments, an occupant of the vehicle may select one or more of the points of interest. In some examples, the display panel 402 of the vehicle may be implemented as a touchscreen. In these examples, an occupant of the vehicle may select the point of interest by touching a related area of the touchscreen. For example, the occupant may touch the touchscreen where a photograph, or photo placeholder, related to the point of interest is displayed. In the example image 500 of FIG. 5, an occupant may touch the touchscreen in one or more of the areas 502 where photographs or videos for the points of interest are displayed, in one or more of the areas 504 where the names of the points of interest are displayed, or in one of more the areas 506 where travel times to the points of interest are displayed. In the example image 600 of FIG. 6, an occupant may touch the touchscreen in one or more of the areas where the map pins 606 are displayed, in one of the more of the areas where the names of the points of interest are displayed, or in one or more the areas where the photographs or videos of the points of interest are displayed. In other embodiments, an occupant of the vehicle may select a point of interest in other ways. For example, the occupant may speak the name of the point of interest, for example by saying “select the lake.” The tour circuit 210 may receive the request, at 318.

In some embodiments, the system may be configured to provide additional information about one or more of the point of interest upon the request of the user. For example, the user may be curious about one or more of the suggested point of interest and may request additional information such as, for example, activities available at the points of interest, shopping or dining opportunities at the point of interest, additional images of the point of interest, user reviews of the points of interest, and so on. This information may be provided to help the user select one or more of the points of interest for visiting.

For example, the tour circuit 210 may provide additional photographs and videos of the point of interest on the display panel 402 of the dashboard 400 of the vehicle. As another example, the tour circuit 210 may employ the speakers 404 of the dashboard 400 of the vehicle to announce further information concerning the selected point of interest, for example such as the name of the point of interest, the location of the point of interest, travel time required to reach the point of interest, operating hours and admission costs of the point of interest, whether meals are available at the point of interest, and the like. The tour circuit may identify the types of the points of interest. The types may include indoor, outdoor, restaurants, museums, parks, and the like.

Referring again to the process 300 of FIG. 3, the tour circuit 210 may receive the user selection of a point of interest, at 318. Responsive to receiving the user selection of the point of interest, the tour circuit 210 may determine a route for the vehicle to reach the point of interest, at 320. For example, the tour circuit 210 may communicate with the navigation system 278 to determine the route. In other embodiments, the tour circuit 210 may communicate with a navigation application executing on a personal communication device operated by one of the occupants, for example such as a smartphone, to determine the route.

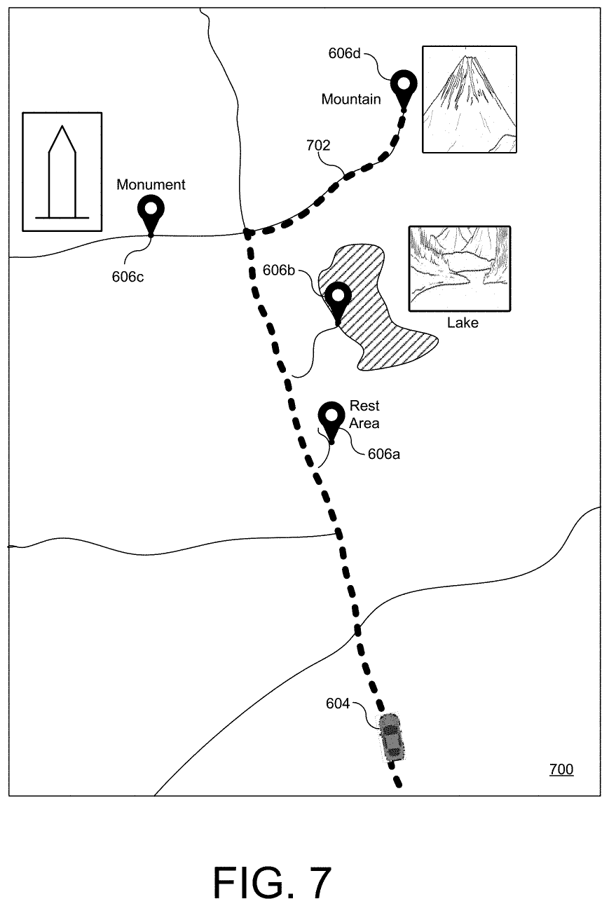

In some embodiments, the tour circuit 210 may display the route, at 318. For example, the tour circuit 210 may display the route on the display panel 402 of the dashboard 400 of vehicle. As another example, the tour circuit 210 may provide information to a portable electronic device operated by one of the occupants that enables that device to display the route. FIG. 7 illustrates an image 700 according to these embodiments. In the example of FIG. 7, an occupant has selected the mountain point of interest, for example by touching the display panel 402 near the map pin 606d for the mountain point of interest. Responsive to the selection, the tour circuit 210 has determined a route to the mountain point of interest, and has displayed the route as part of the image 700, as indicated at 702. In some embodiments, the tour circuit 210 may then provide navigation instructions to the driver for traveling the route to the mountain point of interest.

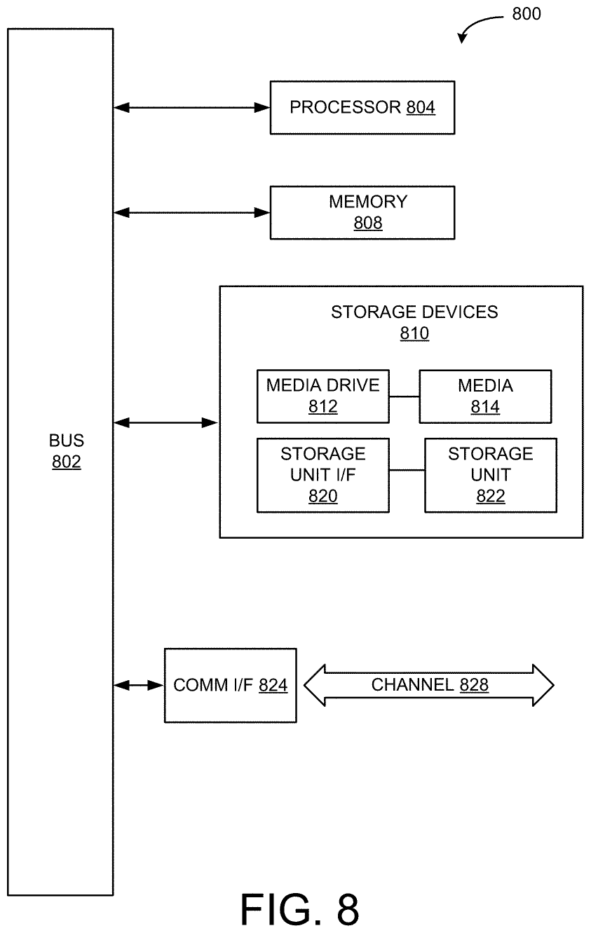

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 8. Various embodiments are described in terms of this example-computing component 800. After reading this description, it will become apparent to a person skilled in the relevant art how to implement the application using other computing components or architectures.

Referring now to FIG. 8, computing component 800 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, portable computing devices, and other electronic devices that might include some form of processing capability.

Computing component 800 might include, for example, one or more processors, controllers, control components, or other processing devices. This can include a processor, and/or any one or more of the components making up user device 102, user system 104, and non-decrypting cloud service 106. Processor 804 might be implemented using a general-purpose or special-purpose processing engine such as, for example, a microprocessor, controller, or other control logic. Processor 804 may be connected to a bus 802. However, any communication medium can be used to facilitate interaction with other components of computing component 800 or to communicate externally.

Computing component 800 might also include one or more memory components, simply referred to herein as main memory 808. For example, random access memory (RAM) or other dynamic memory, might be used for storing information and instructions to be executed by processor 804. Main memory 808 might also be used for storing temporary variables or other intermediate information during execution of instructions to be executed by processor 804. Computing component 800 might likewise include a read only memory (“ROM”) or other static storage device coupled to bus 802 for storing static information and instructions for processor 804.

The computing component 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a solid-state drive, a magnetic tape drive, an optical drive, a compact disc (CD) or digital video disc (DVD) drive (R or RW), or other removable or fixed media drive might be provided. Storage media 814 might include, for example, a hard disk, an integrated circuit assembly, magnetic tape, cartridge, optical disk, a CD or DVD. Storage media 814 may be any other fixed or removable medium that is read by, written to or accessed by media drive 812. As these examples illustrate, the storage media 814 can include a computer usable storage medium having stored therein computer software or data.

In alternative embodiments, information storage mechanism 810 might include other similar instrumentalities for allowing computer programs or other instructions or data to be loaded into computing component 800. Such instrumentalities might include, for example, a fixed or removable storage unit 822 and an interface 820. Examples of such storage units 822 and interfaces 820 can include a program cartridge and cartridge interface, a removable memory (for example, a flash memory or other removable memory component) and memory slot. Other examples may include a PCMCIA slot and card, and other fixed or removable storage units 822 and interfaces 820 that allow software and data to be transferred from storage unit 822 to computing component 800.

Computing component 800 might also include a communications interface 824. Communications interface 824 might be used to allow software and data to be transferred between computing component 800 and external devices. Examples of communications interface 824 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 824 may be carried on signals, which can be electronic, electromagnetic (which includes optical) or other signals capable of being exchanged by a given communications interface 824. These signals might be provided to communications interface 824 via a channel 828. Channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 808, storage unit 820, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system, comprising:
a hardware processor; and
a non-transitory machine-readable storage medium encoded with instructions executable by the hardware processor to perform a method comprising:
determining a route of a vehicle;
determining a current location of the vehicle on the route;
predicting a future location of the vehicle based on the route and current location;
selecting one or more points of interest according to the future location of the vehicle, without human intervention; and
displaying a respective photograph of each selected scenic location on a display of the vehicle.

2. The system of claim 1, the method further comprising:
displaying a map on the display of the vehicle; and
displaying indicators of the points of interest on the map.

3. The system of claim 2, the method further comprising:
receiving a user selection of one of the points of interest;
determining a route to the one of the points of interest; and
displaying the route to the one of the points of interest on the display of the vehicle.

4. The system of claim 1, the method further comprising:
selecting the one or more points of interest according to a profile of an occupant of the vehicle.

5. The system of claim 4, the method further comprising:
selecting the one or more points of interest only when the route is not a route frequently traveled by the occupant.

6. The system of claim 1, the method further comprising:
selecting the one or more points of interest according to criteria concerning the one or more points of interest.

7. The system of claim 6, wherein the criteria include at least one of:
a profile of an occupant of the vehicle;
popularity;
weather conditions;
traffic levels;
predicted times of arrival of the vehicle at the points of interest; and
occurrence of natural disasters.

8. A non-transitory machine-readable storage medium encoded with instructions executable by the hardware processor to perform a method comprising:
determining a route of a vehicle;
determining a current location of the vehicle on the route;
predicting a future location of the vehicle based on the route and current location;
selecting one or more points of interest according to the future location of the vehicle, without human intervention; and
displaying a respective photograph of each selected scenic location on a display of the vehicle.

9. The media of claim 8, the method further comprising:
displaying a map on the display of the vehicle; and
displaying indicators of the points of interest on the map.

10. The media of claim 9, the method further comprising:
receiving a user selection of one of the points of interest;
determining a route to the one of the points of interest; and
displaying the route to the one of the points of interest on the display of the vehicle.

11. The media of claim 8, the method further comprising:
selecting the one or more points of interest according to a profile of an occupant of the vehicle.

12. The media of claim 11, the method further comprising:
selecting the one or more points of interest only when the route is not a route frequently traveled by the occupant.

13. The media of claim 8, the method further comprising:
selecting the one or more points of interest according to criteria concerning the one or more points of interest.

14. The media of claim 13, wherein the criteria include at least one of:
a profile of an occupant of the vehicle;
popularity;
weather conditions;
traffic levels;
predicted times of arrival of the vehicle at the points of interest; and
occurrence of natural disasters.

15. A method comprising:
determining a route of a vehicle;
determining a current location of the vehicle on the route;
predicting a future location of the vehicle based on the route and current location;
selecting one or more points of interest according to the future location of the vehicle, without human intervention; and
displaying a respective photograph of each selected scenic location on a display of the vehicle.

16. The method of claim 15, further comprising:
displaying a map on the display of the vehicle; and
displaying indicators of the points of interest on the map.

17. The method of claim 16, further comprising:
receiving a user selection of one of the points of interest;
determining a route to the one of the points of interest; and
displaying the route to the one of the points of interest on the display of the vehicle.

18. The method of claim 15, further comprising:
selecting the one or more points of interest according to a profile of an occupant of the vehicle.

19. The method of claim 18, further comprising:
selecting the one or more points of interest only when the route is not a route frequently traveled by the occupant.

20. The method of claim 15, further comprising:
selecting the one or more points of interest according to criteria concerning the one or more points of interest.
